(19) United States
(12) Patent Application Publication
(10) Pub. No.: US 2005/0057529 A1
(43) Pub. Date: Mar. 17, 2005

(54) Touch panel

(75) Inventor: Carlos Vicente Mairal Serrano, Zaragoza (ES)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/939,133

(22) Filed: Sep. 10, 2004

(30) Foreign Application Priority Data
Mar. 6, 2003 (WO) PCT/EP03/02309
Mar. 12, 2002 (ES) ES P200200661

(51) Int. Cl. G09G 3/36

(52) U.S. Cl. 345/173

(57) ABSTRACT

A touch-sensitive control panel for an electrical domestic appliance, which can control program selection or multi-stage regulation of power and/or time. The control panel recognizes substantially continuous writing of characters or letters, a figure or a graphic symbol. The control panel includes a plurality of sensor panels to enable the recognition process.

The invention relates to a touch-sensitive control panel of an electrical domestic appliance, in particular for selecting a pre-stored processing sequence (program selection) or one of several previously defined performance steps or operating lengths of this appliance. It is provided in particular for use in a glass ceramic cooktop, which has one of the known types of heating (infrared or halogen or induction heating).

The most widely used type of operating control of electrical domestic appliances is still the traditional rotating or toggle actuator. In certain domestic appliances (dishwashers, washing machines or microwave ovens) one or two such rotating actuators suffice for adjusting operating program, work duration and optionally efficiency of the appliance. As a rule four or more such rotating actuators are used on a control panel to operate an electric stove with several cooking elements, also comprising an integrated baking oven.

Because control panels of electric stoves are arranged at an unfavourable angle for the operator, operation is not known to be optimal. Despite ergonomic improvements, such as a specific inclination of the control panel or an emphasis on assignment between rotating actuators and associated cooking zones through spatial arranging of the rotating actuators or colour coding, operating faults are in no way ruled out. In addition known rotating or toggle actuators are to a large extent mechanical components and as such are relatively expensive in manufacturing and costing terms.

There has been a variety of approaches to practical use of other operating concepts in domestic appliances. Amongst these is the use of sliders, widely known in the audio and video area, just like that on numerical input keyboards.

These alternative operating concepts have not been able to penetrate the market, however. In part they suffered from cost and/or reliability problems, and they were not accepted by customers because of the unusual handling issues.

DE 27 23 325 C3 discloses a sensor switch mechanism for domestic appliances, which is meant to improve the rotating knobs or rocker switches used with sensor fields to the extent that unintentional deletion or alteration to a desired input is prevented. For this a sensor switch or switch field is assigned an additional closely arranged sensor switch, during actuation whereof previous inputs are safeguarded and other (unintentionally placed) inputs are prevented. The programmed function of the appliance is finally activated by actuating a start switch.

DE 196 45 678 C2 discloses an operating unit for switching and controlling domestic appliances, for example kitchen ovens, having a control face with sensors placed behind, and a processor for processing the electrical signals generated by sensors. The control face comprises a rigid, dimensionally stable plate, on the rear of which individual piezosensors are distributed, which react to localised pressure for selecting a function by generating signals of varying intensity.

Different manufacturers of domestic appliances also use the control panels marketed by the firm E.G.O. known under the name “TouchControl”. These comprise a number of sensor fields or keys, which in a glass ceramic cooktop lie under the glass ceramic plate and whereof the position is marked for the user by pressing the plate. Touching one of the sensor fields with a finger effectively sets one of several preset performance steps of a cooking zone by actuating the assigned switch.

The object of the invention is to provide a control panel of the generic type, which can be manufactured cost-effectively and has a long service life and whose usage is easy to understand and is attractive in a way that the use of this control panel ensures a high degree of customer acceptance for the manufacturer of the domestic appliance.

This task is solved by a control panel having the characteristics of claim 1.

The invention includes the essential idea of providing a control panel “writable” with a finger stroke. This type of control panel makes use of the growing trust in so-called touch screens of handheld PC organisers and (recently) also mobile telephones in a growing number of users. It also associates a user-related control concept and gives the user the impression of operating an appliance with technically superior control.

A considerable competitive advantage is afforded the user using the proposed solution over rivals by the novel and attractive operating option. In addition, substantial cost advantages are obtained with the reduction in the number of control elements made possible by the invention in those appliances in which several components are to be controlled separately. Therefore for a comfortable control element of the “Touch Control” type a reduction is made in the number of sensor elements from 17 to 10 including on-off switches, timers, child safety and warming functions.

The proposed control panel in particular comprises a plurality of sensor fields arranged two-dimensional, each of which is assigned a acquisition element for acquiring contact of the respective field, and a controller with a acquisition device connected to the acquisition elements, which responds to a sequence of containing of several sensor fields to recognise the stroke. In the acquisition device an algorithm is implemented for evaluating a touch sequence, which is derived from human writing habits. An intuitively easily learnt control instruction corresponds to this algorithm.

In a particularly effective design the sensor fields are arranged matrix-shaped, and in particular in a 3×3 matrix.

The invention is however certainly not limited to this, but also polygonal, circular or other sensor panel configurations or matrices with another number of lines and columns for certain purposes can be preferred.

The acquisition elements as such can be made to match the concrete application situation according to the prior art.

Control panels, which can be designed with a flexible surface, enable the use of known resistive or piezo-print recorders, whereas the sensors known from the abovementioned “Touch Control” can be used for example for glass ceramic cooktops.

The control panel is preferably assigned at least one display field for displaying a completed input, in particular a set program or a performance step or time duration. Without the control panel itself acting as a display field, control of the settings undertaken is constantly possible for the user.

In an effective design the display field (or each if several display fields are provided) has a 7-segment display. Such displays are particularly cost-effective and are well suited on the basis of their display function for the combination with a control panel of the type proposed.

The inventive control panel can be used in various domestic appliances, especially large domestic appliances such as dishwashers, washing machines, dryers or coolers, but microwave ovens also for example. It is particularly suited for integration into a glass ceramic cooktop, whereby the sensor fields in particular are marked by pressing the glass ceramic plate and the acquisition elements are arranged under the glass ceramic plate. A particularly cost-effective and ergonomically advantageous solution results if all cooking zones of the glass ceramic cooktop are assigned a common control panel and a number of display fields corresponding to the number of cooking zones is arranged outside of this. This substantially reduces the number of control elements for a cooktop or an electric oven, improving the overview for the user and creating an increased design margin.

Also in this application the display fields can preferably comprise a 7-segment display and also comprise a display element for on-off display or warming display. They are arranged adjacent to the control panel in an array corresponding to the arrangement of the cooking zones on the glass ceramic cooktop. For the user control is fast and sure, as to which cooking zone has been switched on and with which power this one is being controlled.

In a particularly advantageous further development of the inventive idea at least some sensor fields are fitted with a secondary input function such that their contact outside a stroke triggers a preset control function.

A number of sensor fields corresponding to the number of cooking zones with a cooking zone selection function and/or one of the sensor fields is fitted with an input cancel function such that its contact cancels at least one previous input. In such a configuration of the control panel for a glass ceramic cooktop no additional control element is required for the selection of the cooking zone(s) to be activated or for cancelling any faulty inputs. It is understood that means for realising multi-stage control are provided in the assigned controller. Such a design of assigned display elements is also advantageous, such that the current input status of the control panel is made clear to the user.

Advantages and uses of the invention will emerge from the independent claims as well as from the following description of preferred embodiments by means of the figures, in which:

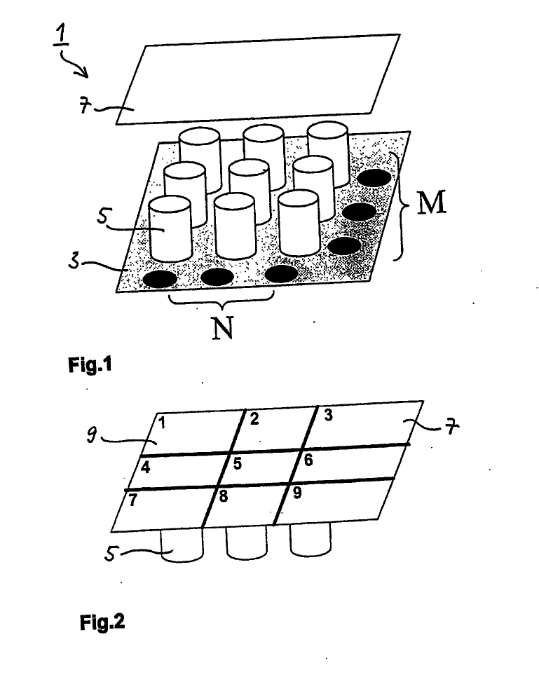

FIG. 1 is a schematic view of an embodiment of the inventive control panel in the form of a perspective exploded illustration,

FIG. 2 is a schematic perspective view of the control panel according to FIG. 1 in the assembled and printed state,

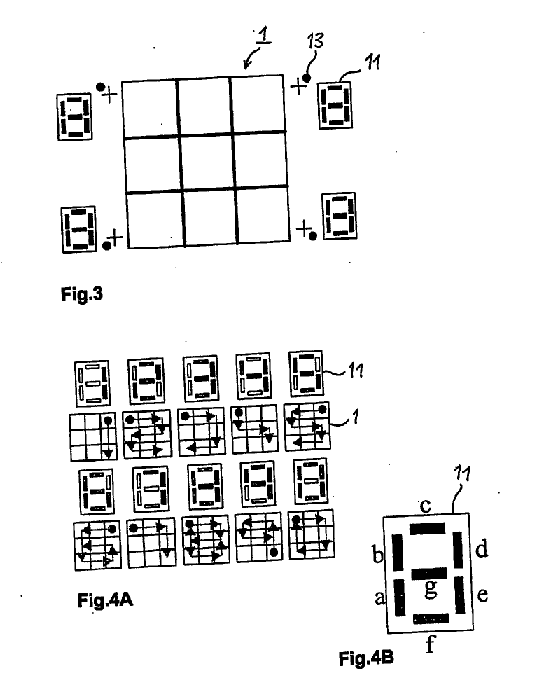

FIG. 3 is a plan view of a control panel of the type shown in FIG. 1 and FIG. 2 with assigned display elements,

FIGS. 4A and 4B clarify the input procedures in a control panel of this type, along with corresponding views of a 7-segment display, and

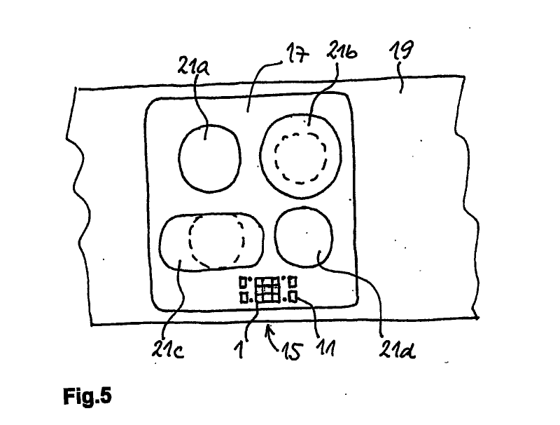

FIG. 5 is a plan view of a glass ceramic cooktop with a control panel of the type shown in FIG. 1 to FIG. 3.

FIG. 1 schematically illustrates an embodiment of the inventive control panel 1 structured as M×N matrix, in which M=3 and N=3. The control panel comprises nine acquisition elements or sensor keys 5 fixed in a support plate 3, which are covered with a cover pane 7. As evident from FIG. 2 the cover pane 7 is subdivided into nine sensor fields 9 corresponding to the regular array of the acquisition elements 5 by pressing on an orderly screen, which are in each case characterised by a figure “1” to “9”. The cover pane can be formed for example by a section of the glass ceramic plate of a cooktop.

In FIG. 3 such a control panel 1 (in which the writing is omitted) in combination with four 7-segment-display elements 11 and four warming display points 13 is combined into a control and display field 15 for four devices to be controlled. As FIG. 5 shows, the control and display field 15 for example can be integrated into a glass ceramic cooktop 17, which is set in the usual manner into a kitchen work space 19, and comprises four cooking zones 21a-21d.

It enables in this arrangement the power control of all cooking zones with a single control element and—not evident in the figures—also the selection of a cooking zone to be activated and cancelling faulty inputs, according to the general designs hereinabove. A cooking zone can be activated for example by marking a corresponding sensor surface, e.g. the sensor surface 3 (FIG. 2) for the cooking zone 21b (FIG. 5). Input of the cooking stage then follows.

FIGS. 4A and 4B illustrate the handling of the control panel 1 by means of comparison with corresponding displays on the 7-segment display 11. FIG. 4a is essentially self-explanatory, to the point where no more precise description is necessary.

With reference to FIG. 4B the sequence of sensor surface contact “1-2-3” is allocated to the segment “c” of the 7-segment display, the sensor surface touch sequence “4-5-6” is allocated in segment “g”, the sensor surface touch sequence “7-8-9” is allocated to segment “f”, the sensor surface touch sequence “1-4” is allocated to segment “b”, the touch sequence “4-7” is allocated to segment “a”, the touch sequence “3-6” is allocated to segment “d” and the touch sequence of fields “6-9” is allocated to segment “e”. It is understood that depending on the concrete size of a sensor matrix or optionally also of a design deviating from the matrix form appropriate touch sequences are possible which match preset actuation and display constellations.

Neither is the embodiment of the invention restricted to the abovedescribed examples, but a number of variations is also possible which are within the scope of expert action.

Legend

1 control panel
3 support plate
5 acquisition element
7 cover pane
9 sensor field
11 7-segment-display element
13 residual warmth display point
15 control and display field
17 glass ceramic cooktop
19 kitchen work space
21a—cooking zone
21d

1-14. (canceled).

15. A touch-sensitive control panel for an electrical domestic appliance, comprising:
an acquisition system for acquiring at least one of a predetermined program selection, a multi-stage regulation of power or a multi-stage regulation of time for the appliance; and
said acquisition system recognizing a substantially continuous writing input to recognize a stroke representing at least one of letters, figures or graphic symbols.

16. The control panel according to claim 15, including a plurality of sensor fields arranged in a two-dimensional structure, each of said sensor fields assigned an acquisition element for acquiring a contact of the respective sensor field and a control including an acquisition device coupled to said acquisition elements, said control responding to a sequence containing a plurality of said sensor fields to recognize said stroke.

17. The control panel according to claim 16, including said plurality of sensor fields arranged in a matrix shaped two-dimensional structure.

18. The control panel according to claim 17, including said plurality of sensor fields arranged in at least a three by three sensor field matrix.

19. The control panel according to claim 16, including said acquisition elements each including an electronic switch element.

20. The control panel according to claim 15, including at least one display device for displaying a completed input of at least one of said program selection, said regulation of power or said regulation of time for said appliance.

21. The control panel according to claim 20, including said display devices including at least a seven-segment display.

22. The control panel according to claim 16, including a glass ceramic cooktop and said sensor fields have a physical marking to indicate each sensor field and said sensor fields are activated by a user pressing on said physical marking and said acquisition elements are arranged under said glass ceramic cooktop.

23. The control panel according to claim 22, including said glass ceramic cooktop including a plurality of cooking zones, said plurality of cooking zones coupled to a common control panel and associated with said control panel are a plurality of display devices corresponding to said plurality of cooking zones.

24. The control panel according to claim 22, including said plurality of display devices, each include at least a seven-segment display and at least one of a control or a warming display segment.

25. The control panel according to claim 23, including said plurality of cooking zones arranged in an array and said plurality of display devices arranged in an array corresponding to said array of cooking zones and adjacent said common control panel.

26. The control panel according to claim 23, including at least some of said sensor fields are equipped with a secondary input function which triggers a preset control function when one of said sensor fields is contacted outside of a stroke.

27. The control panel according to claim 26, including at least one of said sensor fields corresponding to one of said plurality of cooking zones is equipped with a cooking zone selection function.

28. The control panel according to claim 26, including at least one of said sensor fields is equipped with an input delete function, such that contacting said sensor field cancels at least one prior input stroke.

29. An electrical domestic cooking appliance, comprising:
a glass ceramic cooktop;
a touch-sensitive control panel;
an acquisition system for acquiring at least one of a predetermined program selection, a multi-stage regulation of power or a multi-stage regulation of time for said cooktop, said acquisition system including a plurality of sensor fields arranged in a two-dimensional structure, each of said sensor fields assigned an acquisition element for acquiring a contact of the respective sensor field and a control including an acquisition device coupled to said acquisition elements, said control responding to a sequence containing a plurality of said sensor fields to recognize said stroke;
said acquisition system recognizing a substantially continuous writing input to recognize a stroke representing at least one of letters, figures or graphic symbols; and
each of said sensor fields have a physical marking on said glass ceramic cooktop to indicate each sensor field and said sensor fields are activated by a user pressing on said physical marking and said acquisition elements are arranged under said glass ceramic cooktop.

30. The control panel according to claim 29, including said glass ceramic cooktop including a plurality of cooking zones, said plurality of cooking zones coupled to a common control panel and associated with said control panel are a plurality of display devices corresponding to said plurality of cooking zones.

31. The control panel according to claim 29, including said plurality of display devices, each include at least a seven-segment display and at least one of a control or a warming display segment.

32. The control panel according to claim 30, including said plurality of cooking zones arranged in an array and said plurality of display devices arranged in an array corresponding to said array of cooking zones and adjacent said common control panel.

33. The control panel according to claim 30, including at least some of said sensor fields are equipped with a secondary input function which triggers a preset control function when one of said sensor fields is contacted outside of a stroke.

34. The control panel according to claim 33, including at least one of said sensor fields corresponding to one of said plurality of cooking zones is equipped with a cooking zone selection function and including at least one of said sensor fields is equipped with an input delete function, such that contacting said sensor field cancels at least one prior input stroke.
